(19) United States
(12) Patent Application Publication
(10) Pub. No.: US 2008/0311350 A1
(43) Pub. Date: Dec. 18, 2008

(54) UNITIZED COMPOSITES UTILIZING SHRINKABLE LAYERS TO ACHIEVE SURFACE TEXTURE AND BULK

(76) Inventors: James P. Hanson, Lawton, MI (US); Larry L. Pio, Portage, MI (US)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 11/955,191

(22) Filed: Dec. 12, 2007

Related U.S. Application Data
(63) Continuation-in-part of application No. 11/811,978, filed on Jun. 13, 2007.
Application No. 11/811,978 is a continuation-in-part of application No. 11/811,965, filed on Jun. 13, 2007.
(60) Provisional application No. 60/981,255, filed on Oct. 19, 2007.
(60) Provisional application No. 60/981,268, filed on Oct. 19, 2007.

(51) Int. Cl. B32B 1/00; D21F 11/00

(52) U.S. Cl. 428/174; 162/157.1

(57) ABSTRACT

A simplified manufacturing technique to directly form unitized composite structures optionally with at least one relatively flat surface and with at least one surface having raised mound-like elements in an internally-bonded unitized composite is provided. A matrix of fibrous and or other material elements is deposited in un-bonded layers. At least one element is composed of a contractive material which shrinks relative to the other component elements when activated, such as by heating in an oven, to become an internally bonded unitized composite with z-direction raised mound-like texturing after the activation step. Finished product applications and unitized composite webs suitable for finished products employing the inventions are provided.

### CROSS-REFERENCE TO RELATED APPLICATIONS

This application claims priority under 35 U.S.C. §119(e) on U.S. Provisional Application No. 60/981,255 filed on Oct. 19, 2007 and Application No. 60/981,268 filed on Oct. 19, 2007; U.S. Nonprovisional application Ser. No. 11/811,978 filed on Jun. 13, 2007 and U.S. Nonprovisional application Ser. No. 11/811,965 filed on Jun. 13, 2007 the entire disclosures of which are incorporated herein by reference.

### FIELD OF THE INVENTION

The present invention relates to manufacture of unitized composite structures utilizing one or more shrinkable layers to achieve raised three dimensional surface texture and bulk.

### BACKGROUND OF THE INVENTION

Fibers used in nonwovens manufacture are normally selected to assure that a flat, uniform, stable fabric will be produced in the manufacturing process. Fibers that have an undesirable tendency to shrink are often blended with non-shrinking fibers, such as wood pulp, in ratios sufficient to mask or reduce the shrinking tendency of such fibers and the final nonwoven fabric produced from them.

Many end-use applications for nonwovens benefit from having substantial amounts of surface texturing and increased bulk in the fabrics.

Adding raised three dimensional surface texture to a nonwoven fabric normally requires an undesirable separate step in the manufacturing process such as deep embossing that can increase density and reduce bulk of the finished fabric Other known methods of imparting raised elements and three dimensional raised structures in a fabric include use of creping, corrugation and similar mechanical processes which may also produce undesirable reductions in the fabric strength. Additionally, some known methods for making high bulk nonwovens involve exploitation of different shrinking properties of nettings and fibrous assemblies when activated in an oven which are known technologies that have been historically practiced as a way to achieve bulk and overall fabric texturing in both paper and nonwovens.

### SUMMARY OF THE INVENTION

A simplified manufacturing method for directly producing fabrics with a raised, mound-like randomly-textured surface has been discovered using conventional short fiber airlaid process equipment and commonly available materials to achieve a desirable three dimensional texture on selected surfaces or interior layers of composite fabrics without undesirable strength loss, bulk loss or complex manufacturing steps. A layered assembly of loose elements is prepared by depositing layers of fibrous elements or other materials, at least one of the layers comprising fibrous elements or other material having a tendency to contract relative to the fibers or other material in another layer of the assembly when the assembly is exposed to an activation step such as exposure to an elevated temperature. The activation step causes the shrinkable element layer(s) to contract relative to the non-shrinkable layer(s) and to pucker into raised mound-like structures during the activation step. The method results in an internally bonded unitized composite with z-direction raised structures bonded securely to the other elements in the assembly when removed from the activation step.

According to one aspect of the invention, layers of synthetic fibers that contract when activated by heat or some other activation process will cause adjacent non-contracting layers of fibers to develop a three dimensional texture via a bunching effect in the overall structure when activated.

According to another aspect of the invention, the textured layers may be surface layers or may be in the internal layers of the unitized composite fabric after activation.

According to another aspect of the invention, the contracting layer element(s) can be diluted with other non-contracting elements to the extent that the contracting effect remains but is reduced.

According to another aspect of the invention, the contracting tendency and resulting three dimensional surface texturing of the contracting elements can be altered by application of machine direction tension to the assembly during activation.

According to another aspect of the invention, fabrics made with this method can be beneficially used for surface cleaning applications, such as floor mop applications, wiper applications both dry and wet, and many other cleaning pad applications.

According to another aspect of the invention, a fabric made with this method can be used beneficially in skin care applications.

According to another aspect of the invention, a fabric made with this method can be used in filter applications.

According to another aspect of the invention, a fabric made with this method can be used for visually appealing applications, such as window covers, table covers, office partitions, room dividers, or for artistic applications.

According to another aspect of the invention, a fabric made with this method can be used for hygienic products, for example: feminine products, diapers, adult incontinence products, and bandages.

According to another aspect of the invention, a fabric made with this method can be used for cushioning applications.

According to another aspect of the invention, a fabric made with this method can be used for insulative applications.

According to another aspect of the invention, fabrics of this type can be produced on airlaid machines, or other machines capable of making similar fabrics, such as a carding machine.

According to another aspect of the invention, a fiber assembly with these layer(s) may be optionally shaped into a wave-like fabric prior to activating.

According to another aspect of the invention, a fabric with contractible elements in one or more layers will tend to contract in both the machine direction and the cross machine direction. The raised texturing can be beneficially altered by adjusting the machine direction tension applied to the assembly during the activation process.

According to another aspect of the invention, functional attributes, such as scrubbiness, can be included in one or more surface layers if desired.

According to another aspect of the invention, particles may be added to the fabric to provide additional functional attributes.

These and other features, advantages and objects of the present invention will be further understood and appreciated by those skilled in the art by reference to the following specification, claims and appended drawings.

### BRIEF DESCRIPTION OF THE DRAWINGS

FIG. 1 shows an airlaid assembly of loose fiber layers which are optionally compressed.

FIG. 2 shows an assembly of loose fibers which are subsequently bonded into a unitized composite in an activation step.

FIG. 3 shows a flow chart of a process for forming unitized composite according to aspects of this invention.

FIG. 4 shows a method of forming a unitized composite by depositing loose fiber assemblies which are shaped into a wave-like form using a transfer device raised in the z-direction relative to the oven wire and with the oven wire moving at a lower speed to impart wave-like shaping to the entire assembly prior to activation.

FIG. 5 shows a wave-like shaped assembly and the x, y, and z directional conventions used herein.

FIG. 6 is a photograph of the top surface of a fabric containing powdered materials within the assembly, using the texturing method of the invention.

FIG. 7 is a photomicrograph of the cross machine profile of the fabric of FIG. 6.

FIG. 8 is a photograph of the top surface of a 3-layered fabric with top and bottom surfaces textured using the method of the invention.

FIG. 9 is a photograph of the bottom surface of the fabric of FIG. 8.

FIG. 10 is a photomicrograph of the cross machine profile of the fabric of FIG. 8.

FIG. 11 is a photograph of the top surface of a 5-layered fabric made using the texturing method of the invention when the assembly has been formed into a wave-like shaping prior to activation.

FIG. 12 is a photograph of the bottom surface of the fabric of FIG. 11.

FIG. 13 is a microphotograph of the edge of the fabric cut in the machine direction of the fabric of FIG. 11.

### DETAILED DESCRIPTION OF THE INVENTION

Although the invention is illustrated and described herein with reference to specific embodiments, the invention is not intended to be limited in the details shown. Rather, various modifications may be made in the details within the scope and range of equivalents of the claims and without departing from the invention. Also, the embodiments selected for illustration in the figures are not shown to scale and are not limited to the proportions shown.

As used herein, the term “nonwoven” means a web having a structure made of individual fibers which are interlaid, but not in an ordered or identifiable manner such as occurs in a woven or knitted web. As defined broadly by INDA, a trade association representing the nonwovens fabrics industry, nonwoven fabrics are generally “sheet or web structures bonded together by entangling fibers or filaments (and by perforating films) mechanically, thermally or chemically. They are flat, porous sheets that are made directly from separate fibers or from molten plastic or plastic film. They are not made by weaving or knitting and do not require converting the fibers to yarn.”

Nonwoven webs are formed from many processes, such as, for example, airlaying, carding, meltblowing, spunbonding, co-forming, wet forming, scrim and netting extrusion, perforated films, and other such processes. The term “airlaid” implies that a nonwoven web is formed by a dry air-laying process, which deposits assemblies of loose fibers on a substrate such as a porous collecting wire in layers. The term “short fiber airlaid process” refers to a type of dry air-laying process which was originally developed to process relatively short wood pulp fibers for producing disposable fabrics, like high bulk towels and feminine napkin absorbent media. Typical machines used for an air-laying process are supplied by Dan Web A/S and Oerlikon Neumag Denmark A/S of Denmark.

As used herein, the term “bi-component fiber” or “multi-component fiber” refers to a fiber having multiple components such as fibers comprising a core composed of one material (such as a polymer) that is encased within a sheath composed of a different material (such as another polymer with a different melting point). Some types of “bi-component” or “multi-component” fibers can be used as binder fibers that can be bound to one another and to fibers or components to form a unitized structure. For example, in a polymeric fiber, the polymer comprising the sheath often melts at a different, typically lower, temperature than the polymer comprising the core. As a result, such binder fibers provide thermal bonding after appropriate activation, such as by heating in an oven and subsequent cooling, due to melting the sheath polymer, while retaining the desirable fibrous structure characteristics of the core polymer. As an alternative to using a binder fiber, mono- and multi-component filaments, extrusions, films, scrims, netting, particles, powders, emulsion polymers and resins in numerous chemistries can also be used to bond fibrous structures, in addition to mechanical bonding methods such as needlepunching and hydro-entangling.

Composite assemblies are optionally made by including other loose fiber assembly techniques, such as carding techniques, or by including direct process nonwovens methods, such as spunbonding, meltblowing, spunmelting, co-forming, extrusions, or with scrims and films or other techniques. These combinations in layered assemblies can be subsequently bonded together to produce a unitized composite structure using an oven or other activation step to cause the layers to adhere to each other becoming a unitized composite after activation

As used herein, the term “element” refers to one individual component of a structure, assembly, composite, or lamination, i.e., a layer, fiber, particle, filler, or any other component that can be incorporated (e.g., fusion bonded, adhesively bonded, physically bonded by entanglement or the like, or occluded within) into a unitized structure, assembly, composite, or lamination.

As used herein, the term “assembly” refers to a deposition of loose fiber elements or a layered combination of two or more elements of a structure.

As used herein, the terms “unitized structure” or “unitized composite” refer interchangeably to the structure resulting from bonding assemblies in an oven or other device which causes the layers of an assembly to bond together.

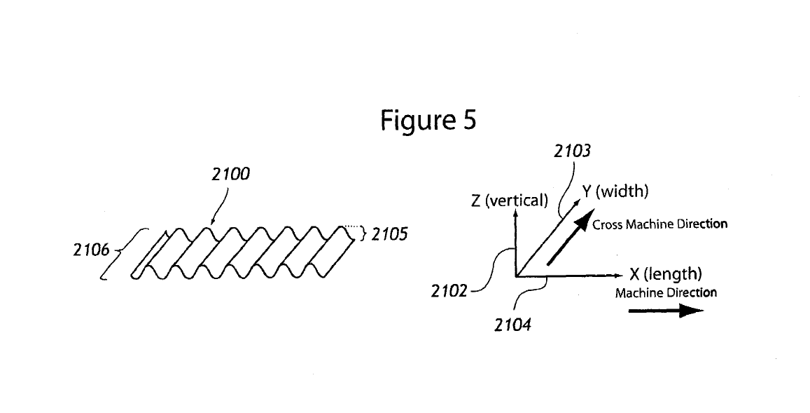

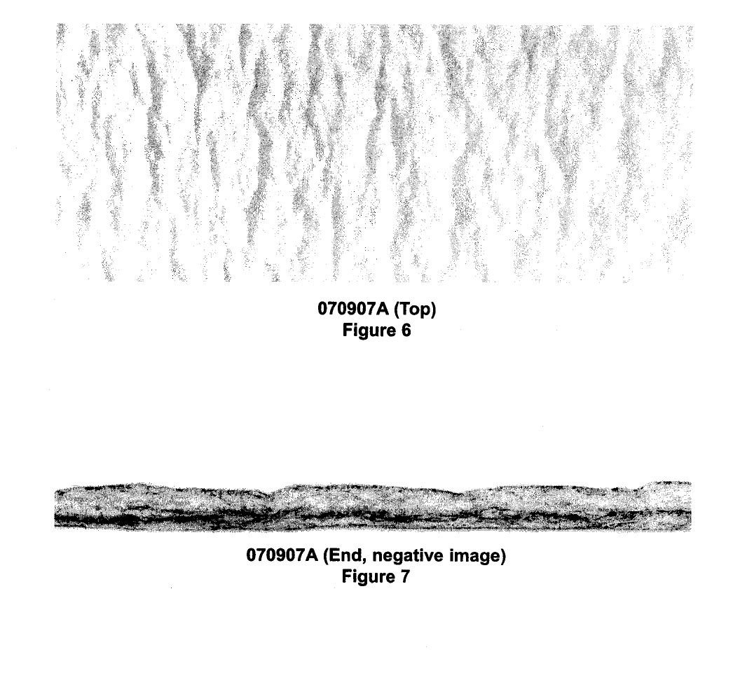

As used herein, the term “wave-like” is used to describe the general shaping of assemblies characterized by a substantially periodic waveform, but not necessarily sinusoidal, perfectly repeating, easily seen, or perfectly parallel, that may be further characterized in terms of wavelength and amplitude, the wavelength being the distance between repeating units of a wave pattern (e.g., measured from one crest to the next crest, or from one trough to the next trough) and the amplitude being the height of the undulations. Alternatively, rather than characterizing the waveform in terms of wavelength, it may be characterized in terms of wavenumber, which is inversely related to wavelength and refers to the number of repeating units of a wave pattern per unit length. The wavenumber is the spacial analogue of frequency. The wave-like form need not be perfectly recurring, i.e., there may be some change in size, shape, or other variation of the generally recurring waveforms. Such wave-like form is depicted generally in an idealized form by 2100 in FIG. 5, and a typical wave form is shown in the photomicrograph of FIG. 6.

As used herein, the term “activation” may be any process, whether with a heated oven, by radiation of electromagnetic energy, or by some other method, which causes shrinkage of the shrinkable elements and bonding to occur between elements and layers when cooled or otherwise removed from activation.

As used herein, the term “recipe” refers to a specific formula of a mixture of various components used in an assembly, including the type and amount of each component.

Exemplary embodiments of the invention will be described with reference to the drawings.

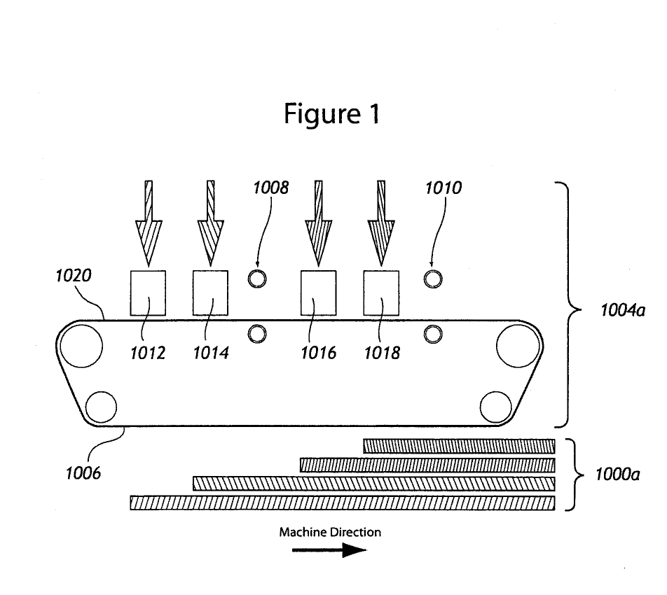

FIG. 1 shows a schematic representation provided as an exemplary system that can be used to form a unitized airlaid composite according to aspects of this invention. Exemplary short fiber airlaid process machinery suitable for the practice of the present invention is available for public use at Marketing Technology Service, Inc. of Kalamazoo Mich. USA, or through Dan Web A/S of Aarhus, Denmark and Oerlikon Neumag Denmark A/S of Horstens, Denmark.

FIG. 1 provides a schematic side view of an exemplary web and complimentary web forming systems showing how layers are deposited on top of each other while moving through respective web-forming systems. The layers of the exemplary webs are not depicted to any particular proportion or scale, but are instead shown schematically for purposes of illustration only. Also, because of some mixing and blending of fibers between the layers of a unitized airlaid structure that occurs during the web-forming process, the layers are not perfectly distinct as depicted in the figures.

Generally, the web forming system illustrated in FIG. 1 shows a machine 1004a having a conveyor surface 1020 which is a porous wire screen 1006 on which the web of the airlaid composite is formed. Fiber-introducing heads 1012, 1014, 1016 and 1018 are positioned above the wire screen in order to deliver the components of the airlaid composite to the screen in a controlled manner. The fiber-introducing heads are configured to introduce the same or different fibers in any combination, as depicted by crosshatching. For example, two or more (or all) of the heads can introduce the same fibers or fiber mixture, or all or some of the heads can introduce different fibers or fiber mixtures. Rolls 1008 and 1010 are also provided in order to selectively modify the web as it passes through the forming system. The schematic representation of the resulting web of the unitized airlaid composite (juxtaposed below the machine in FIG. 1) shows the web portions 1000a provided by each of the heads as those portions build to form the web of the unitized airlaid composite along the machine direction (MD). Again, the web portions can be intermingled at the interfaces between layers in actual airlaid systems as opposed to the distinct zones depicted for purposes of illustration.

Referring to FIG. 1, one exemplary system utilizes a machine 1004a to form a web of an airlaid composite 1000a. The machine 1004a includes a conveyor mechanism 1006 that supports a wire screen 1020 on which the components of the airlaid composites are deposited. A pair of upstream rolls 1008 and another pair of downstream rolls 1010 are provided in such a way that the wire screen 1020 passes between each pair of rolls 1008 and 1010. Multiple heads 1012, 1014, 1016 and 1018 are provided above the wire screen 1020 along the length of the machine 1004a. Illustrated machine 1004a includes four (4) heads, including a first head 1012, a second head 1014, a third head 1016, and a fourth head 1018. First and second heads 1012 and 1014 are positioned upstream from the upstream rolls 1008, and third and fourth heads 1016 and 1018 are positioned downstream from the upstream rolls 1008, and upstream from downstream rolls 1010. The upstream and downstream sets of rolls 1008 and 1010 are optionally utilized as compression rolls. The gap between the rolls 1008 and the gap between the rolls in 1010 is adjustable.

Further, skill practitioners will appreciate that heated compression rolls will produced different results compared to unheated compression rolls, and that variations in the pressure employed in combination with the compression roll temperature will affect results in the following steps, such as shaping the assembly into wave-like shaping, and will also affect final fabric physical attributes. The machine 1004a illustrated in FIG. 1 is shown to have heads 1012, 1014, 1016, and 1018 feeding substantially equal amounts of the same fiber composition. Alternatively, one or more of heads 1012, 1014, 1016, and 1018 optionally feed substantially different amounts of fibers or feed substantially different fibers or fiber compositions. As illustrated in FIG. 1, the machine 1004a does not utilize upstream and downstream rolls 1008 and 1010 as compression rolls (i.e., the gaps between the compression rolls of 1008 and of 1010 are maintained so as to eliminate or minimize compression of the web passing between them). Accordingly, the machine 1004a is configured to yield a relatively thick fabric having a relatively low density. Skilled practitioners will utilize the compression rolls to achieve desired fabric attributes.

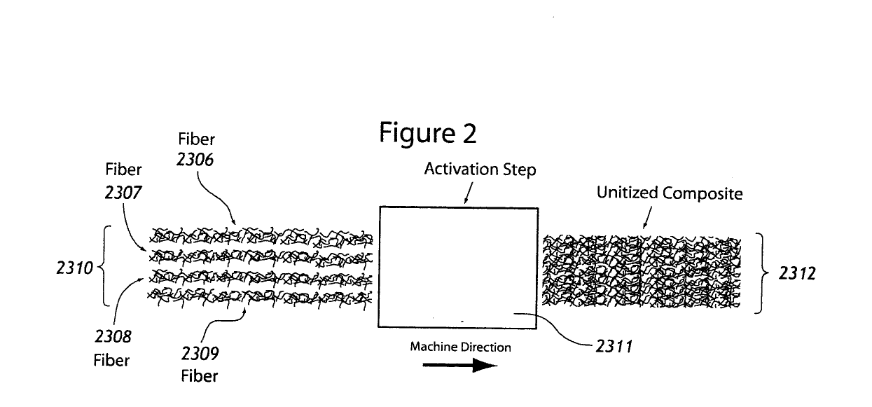

FIG. 2 shows an exemplary assembly 2310 of loose fiber layers 2306, 2307, 2308 and 2309 assembled on top of each other and then bonded together into a single unitized composite 2312 in an oven or other activation step 2311.

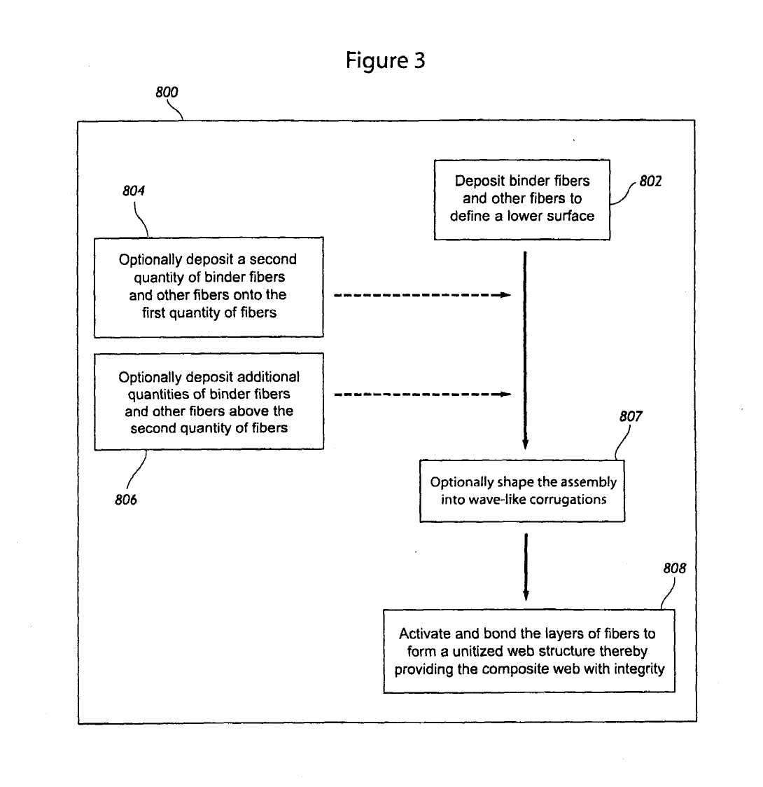

FIG. 3 is a flow chart 800 of exemplary steps for fabricating a unitized airlaid composite in accordance with one embodiment of the present invention. Block 802 illustrates the step of depositing a first quantity of fibers so as to define a layer. Block 804 illustrates the step of depositing a second quantity of fibers onto the first quantity of fibers, wherein the second quantity of fibers is layered on top of the first quantity of fibers to form contacting unbonded, but relatively discrete, layers. Block 806 illustrates the step of depositing an additional concentration(s) of fibers to further construct multiple layers. Block 807 illustrates the additional optional step of shaping the layer assembly into a wave-like form. Block 808 illustrates the final step of activating and bonding the assemblies of fibers together to form a unitized composite structure.

Practitioners skilled in the art will recognize that the recipes of fiber blends, mass amounts of materials deposited in each layer, and the densities of individual layers deposited will affect the behavior of the individual layers during and following activation. Combinations with other potentially desirable materials—such as paper, textile or nonwoven webs, films or similar extruded or roll good systems (including direct process elements made simultaneously during the manufacture of airlaid assemblies)—can be made without departing from the spirit of the inventions. Indeed, such variations are contemplated as being desirable to take advantage of beneficial economies and processing advantages from commercially available roll goods or other assembly methods that may offer properties of technical interest.

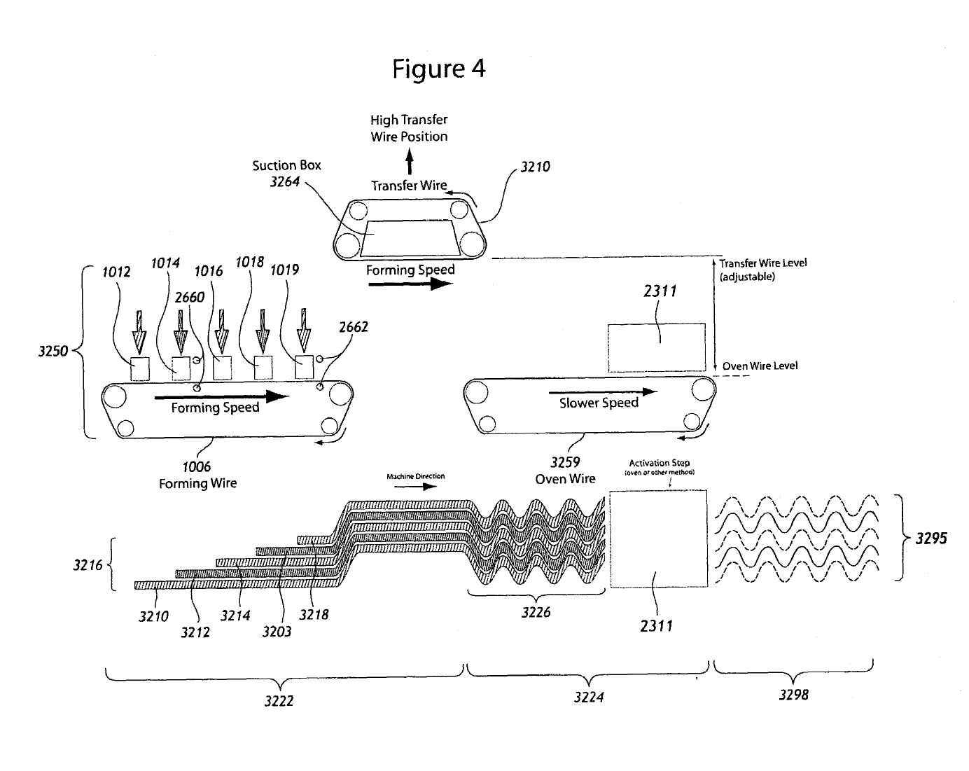

FIG. 4 illustrates practice of one method for shaping the airlaid layered assembly prior to the activation step, using a raised transfer wire device such as is offered for sale by Dan Web A/S of Aarhus, Denmark. The transfer device functions by employing a suction box 3264 to provide vacuum through a moving porous wire belt 3210 closely synchronized in speed to both the oven wire 3259 and the forming wire 1006. The function of the transfer wire in normal operation is to lift the fragile loose fiber assembly from the forming section wire and then deposit the assembly—intact—onto the oven wire where subsequent activation and bonding will occur. To shape the fabric as shown in FIG. 4, the oven wire is slowed, and the transfer wire device optionally raised to control the shaping.

FIG. 5 shows a three-dimensional view of a wave-like element 2100. Such a structure is thicker and lower in overall density relative to a flat surface of similar formulation. FIG. 5 also provides a reference to demonstrate the x, y, and z direction conventions that are referred to herein, showing the length 2104 (x or machine direction), width 2103 (y or cross machine direction) and vertical height 2102 (z direction) of a continuous assembly.

Table 1 lists the components of an exemplary fabric using the invention to make a floor mop fabric with a scrubby surface.

TABLE 1

Layer 3 (Top Layer): Fibervisions ALAD 1.7 dtex bonding fiber
Layer 2: Trevira 1.7 dtex Type 255 bonding fiber 30%
Wood Pulp 75 %
Superabsorbent Polymer (SAP) 5%
Layer 1: (Bottom layer): Fibervisions 3.3 dtex AL-Delta II

In this example, the bottom layer (to be contacted against the floor surface) is a layer of FiberVisions' 3.3 dtex AL-Delta II fiber (a bi-compoent fiber having a polypropylene core and a polyethylene sheath). The Fibervisions AL-Delta II bonding fiber, manufactured by Fibervisions A/S of Varde, Denmark, is utilized by the present invention in an unconventional way to achieve a scrubby/abrasive effect on the fabric surface. A bi-component bonding fiber is normally utilized as a minority component in an airlaid fabric for development of strength when activated. The AL-Delta II fiber contracts, and exhibits the abrasive effect when used as a majority component of a surface layer, when the fabric is heated near, at, or above the melting temperature of the polymer used in the core of the bonding fiber which would not be normally done according to normal bonding procedures used for it's bonding function. Dilution of the surface abrasive layer with other materials, for example other bonding fibers, or other non-bonding synthetic or natural fibers, may be used to control shrinkage, to temper the abrasive effect, or provide a secondary abrasive component (as for example using polyester or metal fibers) or other functional attributes, such as absorbency, or fire retardency etc.

The inside layer(s) of the exemplary floor mop or wiping structure of Table 1 include wood pulp with a conventional bi-component bonding fiber having a polyester core and a lower melting temperature polyester sheath (for example, Trevira type 255, 1.7 dtex, manufactured by Trevira GmbH of Bobingen, Germany). Inclusion of an absorbency aid such as superabsorbent polymer (SAP) or superabsorbent fiber (SAF) may also be used for the applications. Nonlimiting examples of super absorbents polymer particulates include those formed from hydrolyzed cross-linked polyacrylamides, polyacrylates, polymers of acrylic polymers, or their copolymers. A top or intermediate layer made of predominantly a shrinking bonding fiber, such as Fibervisions ALAD 1.7 dtex bi-component fiber (having a polypropylene core and a polyethylene sheath) optionally improves the surface strength of the fabric and provides the mode of texturing the fabric. The exemplary floor mop product of Table 1 may be optionally shaped by waving technology prior to activation to provide raised and recessed regions where dirt materials can be trapped, and also increasing the net pressure (by reducing the overall contacting surface area) achieved by localized areas of the fabric in contact with the surface to be cleaned.

The floor contacting surface of the floor mop product of Table 1, whether shaped additionally by optional pre-activation waving technology, can be further modified by selection of activation step parameters, such as, in the case of an oven activation step, air pressure applied to the airlaid fabric against the oven wire (in a through air oven), oven temperature, and the application of suitable tension on the web as it exits the activation step, for example an oven, prior to cooling. Cooling of the sheet after any shaping and activation is then required to preserve the desirable shaping. Any lamination steps would be done after the fabric has been cooled.

Table 2 lists the component layers of an exemplary fabric suitable for use in wiping and cleaning pad applications.

TABLE 2
Layer 3 (Top Layer): Trevira 1.7 dtex Type 255 bonding fiber 50%
Wellman Fortrel 6.67 dtex PET fiber 50%
Layer 2: Fibervisions AL Delta II 3.3 dtex bonding fiber
Layer 1: (Bottom layer): Trevira 1.7 dtex Type 255 bonding fiber 50%
Wellman Fortrel 6.67 dtex PET fiber 50%

The fabric can be made with one or both surfaces having the shaped texture by use of one or more fibers providing the shrinking characteristics, such as the AL-Delta II fiber, for the shrinking untextured layer. It is often desirable in wipe and cleaning pad applications to reduce or eliminate the wood pulp fraction and to replace that portion of the textured layers with typically used synthetic fibers, such as a Fortrel 6.67 dtex polyethylene terephthalate PET, as manufactured by Wellman, Inc. of Fort Mill, S.C., or to replace a portion of the internal layers with additional bonding fiber, in both cases to inhibit potential Tinting, improve bulk, and to maintain fabric strength for repeated use cycles when wiping or scrubbing.

Table 3 lists the component layers of an exemplary fabric for use as a lamp shade or window covering.

TABLE 3
Layer 3 (Top Layer): Trevira 1.7 dtex Type 255 bonding fiber 60%
Wellman Fortrel 6.67 dtex PET fiber 40%
Layer 2: Fibervisions ALAD 1.7 dtex bonding fiber
Layer 1: (Bottom layer): Trevira 1.7 dtex Type 255 bonding fiber 60%
Wellman Fortrel 6.67 dtex PET fiber 40%

Use of the Fibervisions ALAD for the shrinking layers, provides texture to the non-shrinking layers comprised of the bi-component Trevira bonding fiber, and the Fortrel PET. Colored fibers with similar attributes to these fibers could provide additional decorative attributes with this, and with other uses noted in the invention.

The optional pre-activation shaping into a wave-like shaping for the formulas of Tables 2 and 3 is suitably applied for many other uses, including visual, artistic and decorative purposes, and for improving softness and drape.

Table 4 lists the component layers of an exemplary 4-layer fabric, which can be used as an absorbent hygienic product.

TABLE 4
Layer 4 (Top Layer): Trevira 1.7 dtex Type 255 bonding fiber
Layer 3: Trevira 1.7 dtex Type 255 bonding fiber 50%
Wellman Fortrel 3.3 dtex PET fiber 50%
Layer 2: Trevira 1.7 dtex Type 255 bonding fiber 14%
Wood Pulp 36%
Superabsorbent Polymer (SAP) 50%
Layer 1 (Bottom Layer): Fibervisions ALAD 1.7 dtex bonding fiber

The bottom layer uses only Fibervisions ALAD 1.5 denier bonding fiber. The second layer contains super absorbent particles, wood pulp and Trevira 1.5 denier bonding fiber. The third layer contains Fortrel 3.0d PET fiber and Trevira 1.5 denier bonding fiber. The top layer uses only Trevira 1.5 denier bonding fiber. The inside layers and the top layer are textured due to the shrinkage of the bottom layer.

Practitioners skilled in the art can appreciate that substitutions of the materials described above, can be made by a wide variety of materials to achieve the functions noted, without departing from the spirit of the invention.

FIG. 6 is a photograph of the top surface of the fabric as described in Table 4, showing the texturing of this fabric. The bottom surface of this fabric is flat.

FIG. 7 is a photomicrograph of the cross machine profile of the fabric of Table 4. As you can see with FIGS. 6 and 7, the texturing of this fabric on the top surface is somewhat subtle.

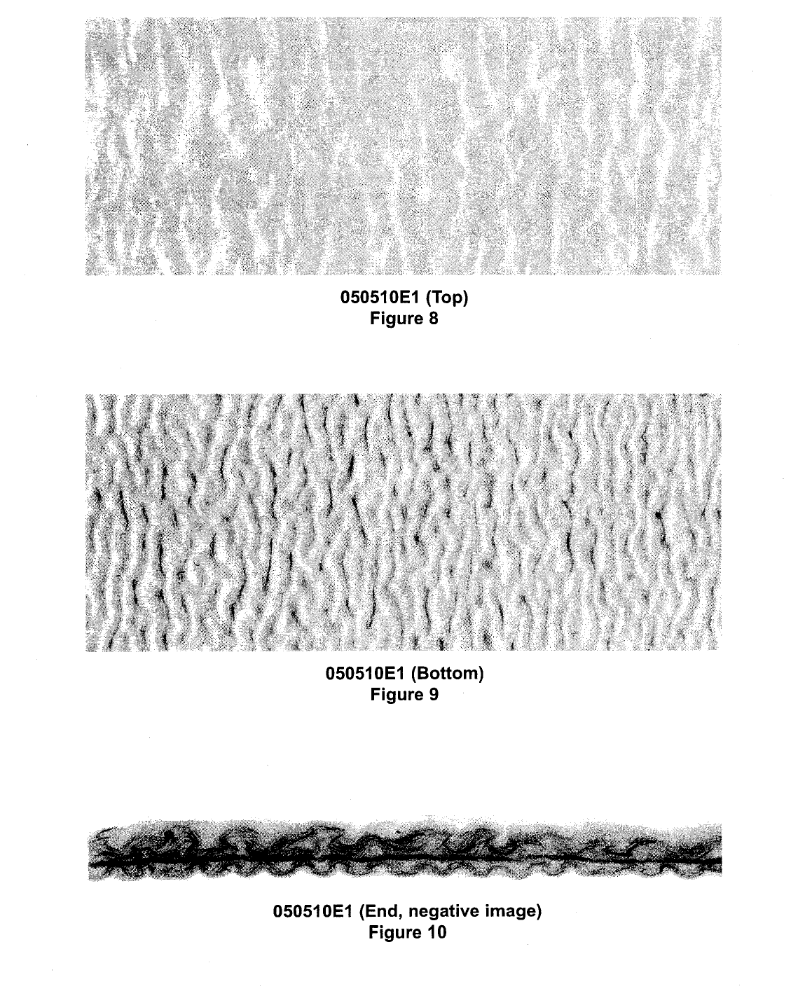

FIG. 8 is a photograph of the top surface of a 3-layered fabric with both the top and bottom surfaces textured using the method of the invention. In this exemplary fabric, the top layer of fibers is a blend of 60% Tencel 6 mm fibers available from Lenzing Fibers Ltd. of Grimsby, UK, with 40% 1.5 denier Trevira bonding fiber. The middle layer is a blend of 60% Delta II 6 denier bonding fibers with 40% ALAD 1.7 denier bonding fibers. The bottom layer is also 60% Tencel 6 mm fibers, with 40% 1.5 denier Trevira bonding fiber. The shrinking of the Delta II/ALAD middle layer occurs primarily in the cross machine direction, which is the predominant mode of shrinkage in assemblies that have not been shaped by using a waving technique.

FIG. 9 is a photograph of the bottom surface of the fabric of FIG. 8. Note the surfaces are somewhat different, even though the formulas are the same.

FIG. 10 is a microphotograph of the cross machine profile of the fabric of FIG. 8. FIG. 10 displays the textured top and bottom surfaces, and the flat middle layer.

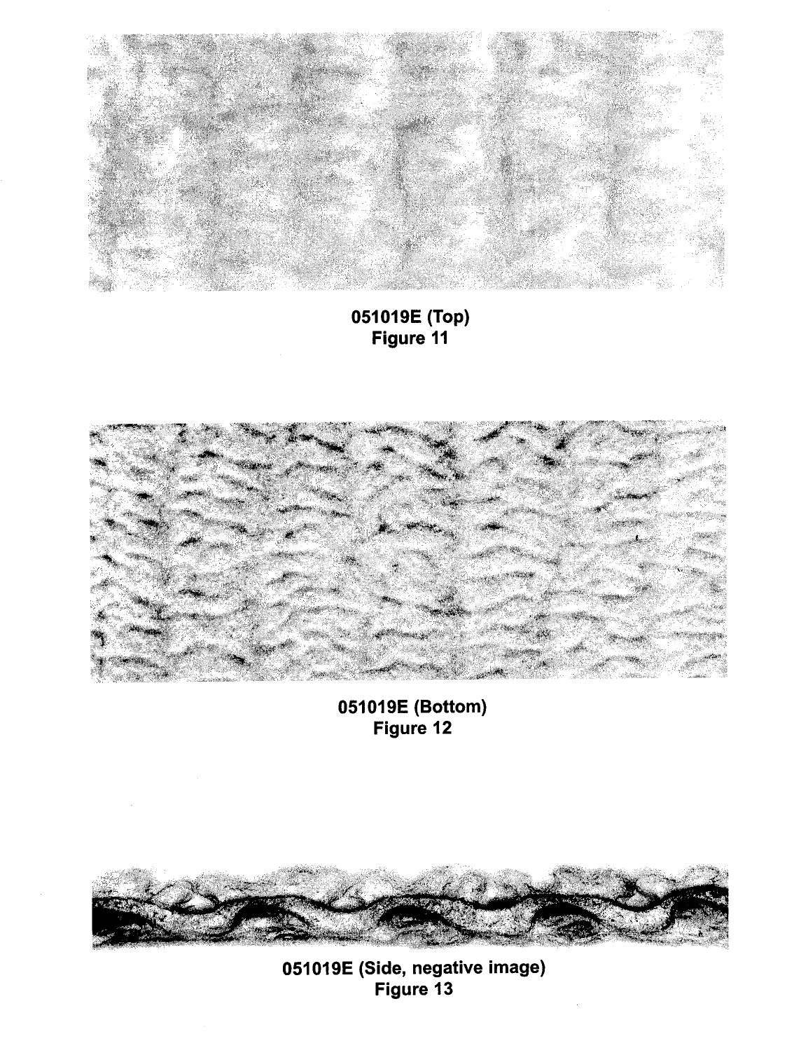

FIG. 11 is a photograph of the top surface of a 5-layered fabric of an exemplary pre-waved fabric, which also uses the texturing method of the present invention. In this case the appearance of the resulting texturing and shaping of the raised mound-like structuring after activation appears to be random in both the machine direction and in the cross machine direction and is visually appealing and unusual. In this exemplary fabric the bottom layer consists of a blend of 25% Kosa 255 2.2 denier bonding fiber available from Invista Sarl of Charlotte, N.C. and 75% 0.8 denier Wellman PET fiber. The second layer is Delta II 6 denier bonding fiber. The third layer is 30% Trevira 1.5 denier bonding fiber blended with 70% 8.0 denier Wellman PET. The fourth layer is Delta II 6 denier bonding fiber. The top layer is 60% Trevira 1.5 denier bonding fiber with 40% Tencel. In this example, layers 2 and 4 are providing shrinking forces both in the machine and cross machine directions due to waving technique used in addition to the texturing method of this invention.

FIG. 12 is a photograph of the bottom surface of the fabric of FIG. 11.

FIG. 13 is a photomicrograph of the edge of the fabric of FIG. 11 cut in the machine direction. This photomicrograph displays the waved layers, especially the denser layers 2 and 4.

While some embodiments of the invention have been described herein, embodiments are provided by way of example only, in part because of the flexibility in selection of materials to provide functional equivalency to the invention. Such flexibility ensures that other applications, variations, changes, and substitutions will occur to those skilled in the art without departing from the spirit of the present invention.

The uses and benefits conferred by this invention are also applicable in many fields including, but not limited to fabric components and finished products for household consumer applications, filters, absorbent products of many kinds, insulative applications, cushioning applications or decorative applications such as window and wall coverings.

The above description is considered that of exemplary embodiments only. Modifications of the invention will occur to those skilled in the art and to those who make or use of the invention. Therefore, it is understood that the embodiments shown in the drawings and described above are merely for illustrative purposes and not intended to limit the scope of the invention, which is defined by the following claims as interpreted according to the principles of patent law, including the doctrine of equivalents.

The invention claimed is:

1. A unitized composite web comprising a three dimensionally shaped dry laid assembly wherein at least one layer of contractive fibers, nonwovens, or roll goods, and at least one layer of non-contractive fibers, nonwovens, or roll goods are deposited in a flat layered assembly and subsequently activated to produce a unitized internally bonded fabric with raised mound-like structures.

2. A unitized composite of claim 1 wherein the raised mound-like structures are on one or both surfaces and/or are on one or more interior layers.

3. A unitized composite web of claim 1 wherein at least one surface or one or more optionally present interior layer(s) is relatively flat after activation.

4. A unitized composite web of claim 1 wherein said unitized composite optionally includes particles in the interior layer(s) or in an outer layer of the unitized composite web.

5. A unitized composite of claim 1 wherein said web optionally has a sufficient stiffness to be a self supporting semi-rigid composite.

6. The personal care product incorporating the unitized composite web of claim 1 which is configured for use in a diaper, training pant, incontinence product, breast pad or feminine hygiene product, bandage, or drip and spill absorbent pad.

7. The personal care product incorporating the unitized composite web of claim 1 which is an examining room table and/or chair covering, headrest material or other disposable surface protector.

8. The personal care product incorporating the unitized composite web of claim 1 which is an acquisition and/or cover stock layer.

9. The end product incorporating the unitized composite web of claim 1 which is a cushioning material product.

10. The end product incorporating the unitized composite web of claim 1 which is a dry wiper or wet wiper.

11. The end product incorporating the unitized composite of claim 1 which is an acoustical or thermal insulation product.

12. The end product incorporating the unitized composite of claim 1 which is a wet or dry disposable floor mop.

13. The end product incorporating the unitized composite of claim 1 which is a filter for gaseous or liquid applications.

14. The end product incorporating the unitized composite of claim 1 which is a protective apparel application suitable for industrial, laboratory, military apparel, clean room wear, operating room gowns and drapes, and other disposable and non-disposable apparel.

15. The end product incorporating the unitized composite of claim 1 which is a napkin, placemat or table covering.

16. A process for making a three dimensionally shaped unitized composite including a contractible material comprising at least one layer selected from fibers, nonwovens, and roll goods deposited in a flat layered assembly, and subsequently activating the assembly to produce a unitized composite web having raised mound-like structures.

17. The process of claim 16 where the shrinkable fiber within the shrinkable element is a bi-component or multi-component synthetic fiber.

18. The process of claim 16 where the shrinkable fiber within the shrinkable element is a mono-component synthetic fiber.

19. The process of claim 16 where the layered assembly is deposited on an airlaid or similar dry process machine.

20. The process of claim 16 where the layered assembly is shaped by waving prior to activation of the shrinking behavior.

21. The process of claim 16 where the appearance and type of raised surface texturing is controlled by adjusting machine direction tension applied to the assembly as it exits the activation step.

22. The process of claim 21 where the activation step is an oven.
